(19) United States
(12) Patent Application Publication
(10) Pub. No.: US 2023/0227724 A1
(43) Pub. Date: Jul. 20, 2023

(54) INSULATION MATERIAL INCLUDING INORGANIC FIBERS AND ENDOTHERMIC MATERIAL

(71) Applicant: UNIFRAX I LLC, Tonawanda, NY (US)

(72) Inventors: Michael J. ANDREJCAK, Buffalo, NY (US); Matthew R. GEISE, Newfane, NY (US); Kenneth B. MILLER, Lockport, NY (US)

(21) Appl. No.: 18/186,306

(22) Filed: Mar. 20, 2023

Related U.S. Application Data
(63) Continuation of application No. PCT/US2021/051671, filed on Sep. 23, 2021.
(60) Provisional application No. 63/082,608, filed on Sep. 24, 2020.

(51) Int. Cl. C09K 21/02; C03C 13/00; C03C 3/078; E04B 1/78; E04B 1/94; C03C 25/42; C03C 25/146; C03C 25/1095; C03B 37/04

(52) U.S. Cl. CPC C09K 21/02; C03C 13/00; C03C 3/078; E04B 1/78; E04B 1/941; C03C 25/42; C03C 25/146; C03C 25/1095; C03B 37/048; C03C 2213/00

(57) ABSTRACT

A thermal insulation material includes inorganic fibers and an endothermic material dispersed throughout the inorganic fibers. The endothermic material may be incorporated into the inorganic fibers during a fiber attenuation process. The endothermic material may be particles entangled within a web of the inorganic fibers or may be coated onto surfaces of the inorganic fibers.

### CROSS-REFERENCE TO RELATED APPLICATIONS

The present application is a continuation of PCT International Application No. PCT/US2021/051671 filed Sep. 23, 2021, and entitled “INSULATION MATERIAL INCLUDING INORGANIC FIBERS AND ENDOTHERMIC MATERIAL,” which claims priority to U.S. Provisional Application No. 63/082,608 filed Sep. 24, 2020, and entitled “INSULATION MATERIAL INCLUDING INORGANIC FIBERS AND ENDOTHERMIC MATERIAL,” the entirety of which are hereby incorporated by reference.

### TECHNICAL FIELD

The present disclosure relates to a thermal insulation material. More particularly, the present disclosure relates to a thermal insulation material including inorganic fibers and an endothermic material.

### BACKGROUND

There is a continuing need for fire protection materials that dissipate heat and deter the spread of flames, smoke, vapors and/or heat during a fire. Various materials have been used to protect surfaces from excessive heat and flame, including, among others, insulative materials, endothermic materials, intumescent materials, opacifiers, and so-called “superinsulation materials.” The use of insulative materials such as ceramic or bio-soluble blankets, felt or thick paper-like material, or mineral wool blankets and boards are problematic because the materials are typically very thick and/or heavy. These materials are bulky and difficult to install. In addition, insulative materials can become detached from surfaces when the heat of a fire expands or destroys the means by which the insulative materials are attached.

Endothermic materials absorb heat, typically by releasing water of hydration, by going through a phase change that absorbs heat (i.e., liquid to gas), or by other physical or chemical change where the reaction requires a net absorption of heat to take place. Infrared opacifiers, such as carbon black, titanium dioxide, iron oxide, or zirconium dioxide, as well as mixtures of these, reduce the radiation contribution to thermal conductivity. When activated, endothermic materials and opacifiers restrict heat transfer and, consequently, keep the cold-face temperature (i.e., the temperature at the side opposite the heat source) lower than it would be absent such materials.

In certain applications, such as grease duct insulation, the insulation materials must be able to withstand a maximum cold-face temperature below a set threshold for a predetermined period. For instance, the ASTM E2336 test requires a maximum cold face temperature of 325° F. above ambient for 30 minutes, measured from when the hot-face temperature (i.e., the temperature at the side facing the heat source, e.g., the inside of a grease duct) reaches 2000° F.

One ASTM E2336 tested material is available from Unifrax I LLC under the trademark FYREWRAP® ELITE® 1.5. The FYREWRAP® ELITE® 1.5 Duct Insulation is a two-layer flexible enclosure for two-hour rated commercial kitchen grease ducts and is acceptable as an alternate to a traditional fire-rated shaft. However, the FYREWRAP® ELITE® 1.5 system requires two 1.5″ thick layers. Each layer is formed of a calcium magnesium silicate blanket encapsulated by a sodium silicate foil adhered to the outside surfaces thereof. The requirement of a two-layer configuration results in added manufacturing and installation costs. Moreover, the two-layer system requires at least 3 inches of clearance around the grease duct. As such, there remains a need for a fire barrier system with decreased thickness that can still provide requisite fire protection and insulation.

The insulation material according to the present disclosure is able to pass the ASTM E2336 test while potentially including significantly less material than conventional fire barrier systems. As compared with conventional systems, the insulation material of the present disclosure can decrease labor costs, decrease space demands, and decrease weight.

### BRIEF DESCRIPTION OF THE DRAWINGS

FIG. 1 is a diagrammatic representation of a system for producing a thermal insulation material according to an embodiment of the present disclosure.

### DETAILED DESCRIPTION

The thermal insulation material of the present disclosure comprises inorganic fibers coated with an endothermic material. The relative amounts of inorganic fibers and endothermic material in the thermal insulation material are not particularly limited. In some embodiments, the endothermic material is a solid dispersed or entangled within the inorganic fibers, and a weight percentage of the endothermic material, based on a total weight of the endothermic material and the inorganic fibers, is 10-90 wt %, 20-80 wt %, 30-70 wt %, 35-65 wt %, 40-60 wt %, 40-55 wt %, 40-50 wt %, 42-50 wt %, or 42-45 wt %. In other embodiments, the endothermic material is a liquid coated onto the inorganic fibers, the endothermic material is present in an amount, based on a total weight of the endothermic material and the inorganic fibers, of 0.1 to 40 wt %, 1 to 30 wt %, 5 to 25 wt %, 10 to 25 wt %, 1 to 20 wt %, 5 to 20 wt % or 10 to 20 wt %.

According to certain embodiments, the inorganic fibers that may be used to prepare the thermal insulation material comprise, without limitation, at least one of high temperature resistant biosoluble inorganic fibers, conventional high temperature resistant inorganic fibers, or mixtures thereof. In some embodiments, the thermal insulation material comprises one or more layers of inorganic fibers, wherein the respective layers may be of the same or differing composition.

For purposes of illustration but not by way of limitation, suitable conventional heat resistant inorganic fibers that may be used to prepare the thermal insulation material include refractory ceramic fibers, alkaline earth silicate fibers, mineral wool fibers, leached glass silica fibers, fiberglass, glass fibers and mixtures thereof. In some embodiments, the mineral wool fibers include without limitation, at least one of rock wool fibers, slag wool fibers, basalt fibers, glass wool fibers, and diabasic fibers. Mineral wool fibers may be formed from basalt, industrial smelting slags and the like, and typically comprise silica, calcia, alumina, and/or magnesia. Glass wool fibers are typically made from a fused mixture of sand and recycled glass materials. Mineral wool fibers may have a diameter of from 1 to 20 μm, and in some instances from 5 to 6 μm.

According to some embodiments, the high temperature resistant inorganic fibers that may be used to prepare the thermal insulation material include, without limitation, high alumina polycrystalline fibers, refractory ceramic fibers (RCFs) such as alumino-silicate fibers, alumina-magnesia-silica fibers, kaolin fibers, alkaline earth silicate fibers such as calcia-magnesia-silica fibers and magnesia-silica fibers, S-glass fibers, S2-glass fibers, E-glass fibers, quartz fibers, silica fibers, leached glass silica fibers, fiberglass, or mixtures thereof. RCFs typically comprise alumina and silica, and in certain embodiments, the alumino-silicate fiber may comprise from 45 to 60 weight percent alumina and from 40 to 55 weight percent silica. The RCFs are a fiberization product that may be blown or spun from a melt of the component materials. RCFs may additionally comprise the fiberization product of alumina, silica and zirconia, in certain embodiments in the amounts of from 29 to 31 weight percent alumina, from 53 to 55 weight percent silica, and 15 to 17 weight percent zirconia. RCF fiber length may be in the range of 3 to 6.5 mm, typically less than 5 mm, and the average fiber diameter range may be from 0.5 μm to 14 μm.

According to some embodiments, the heat resistant inorganic fibers that are used to prepare the thermal insulation material comprise ceramic fibers. Without limitation, suitable ceramic fibers include alumina fibers, alumina-silica fibers, alumina-zirconia-silica fibers, zirconia-silica fibers, zirconia fibers and similar fibers. A useful alumino-silicate ceramic fiber is commercially available from Unifrax I LLC (Tonawanda, N.Y.) under the registered trademark FIBERFRAX®. The FIBERFRAX® ceramic fibers comprise the fiberization product of a melt comprising 45 to 75 weight percent alumina and 25 to 55 weight percent silica. The FIBERFRAX® fibers exhibit operating temperatures of up to 1540° C. and a melting point of up to 1870° C. The FIBERFRAX® fibers are easily formed into high temperature resistant sheets and papers. In certain embodiments, the alumino-silicate fiber may comprise from 40 weight percent to 60 weight percent alumina and from 40 weight percent to 60 weight percent silica, and in some embodiments, from 47 to 53 weight percent alumina and from 47 to 53 weight percent silica. The FIBERFRAX® fibers are made from bulk alumino-silicate glassy fiber having approximately 50/50 alumina/silica and a 70/30 fiber/shot ratio. 93 weight percent of this paper product is ceramic fiber/shot, the remaining 7 weight percent being in the form of an organic latex binder. The FIBERFRAX® refractory ceramic fibers may have an average diameter of 1 micron to 12 microns.

High temperature resistant fibers, including ceramic fibers, which are useful in the thermal insulation material include those formed from basalt, industrial smelting slags, alumina, zirconia, zirconia-silicates, chromium, zirconium and calcium modified alumino-silicates and the like, as well as polycrystalline oxide ceramic fibers such as mullite, alumina, high alumina aluminosilicates, aluminosilicates, titania, chromium oxide and the like. In certain embodiments, the fibers are refractory. When the ceramic fiber is an aluminosilicate, the fiber may contain between 55 to 98 weight percent alumina and between 2 to 45 weight percent silica, and in certain embodiments the ratio of alumina to silica is between 70 to 30 and 75 to 25. Suitable polycrystalline oxide refractory ceramic fibers and methods for producing the same are disclosed in U.S. Pat. Nos. 4,159,205 and 4,277,269, which are incorporated herein by reference. FIBERMAX® polycrystalline mullite ceramic fibers are available from Unifrax I LLC (Tonawanda, N.Y.) in blanket, mat or paper form. The alumina/silica FIBERMAX® polycrystalline mullite ceramic fibers comprise from 40 weight percent to 60 weight percent Al₂O₃ and from 40 weight percent to 60 weight percent SiO₂. The fibers may comprise 50 weight percent Al₂O₃ and 50 weight percent SiO₂. The alumina/silica/magnesia glass fibers typically comprise from 64 weight percent to 66 weight percent SiO₂, from 24 weight percent to 25 weight percent Al₂O₃, and from 9 weight percent to 10 weight percent MgO. The E-glass fibers typically comprise from 52 weight percent to 56 weight percent SiO₂, from 16 weight percent to 25 weight percent CaO, from 12 weight percent to 16 weight percent Al₂O₃, from 5 weight percent to 10 weight percent B₂O₃, up to 5 weight percent MgO, up to 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

In certain embodiments, biosoluble alkaline earth silicate fibers such as calcia-magnesia-silicate fibers or magnesium-silicate fibers may be used to prepare the layers of the thermal insulation material. The term “biosoluble” inorganic fibers refers to fibers that are decomposable in a physiological medium or in a simulated physiological medium such as simulated lung fluid. The solubility of the fibers may be evaluated by measuring the solubility of the fibers in a simulated physiological medium over time. A method for measuring the biosolubility (i.e.—the non-durability) of the fibers in physiological media is disclosed in U.S. Pat. No. 5,874,375, although other methods are also suitable for evaluating the biosolubility of inorganic fibers. Without limitation, suitable examples of biosoluble inorganic fibers that can be used to prepare the fire-blocking paper include those biosoluble inorganic fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,975, 5,821,183, and 5,811,360, each of which are incorporated herein by reference. According to certain embodiments, the biosoluble inorganic fibers exhibit a solubility of at least 30 ng/cm²-hr when exposed as a 0.1 g sample to a 0.3 ml/min flow of simulated lung fluid at 37° C. According to other embodiments, the biosoluble inorganic fibers may exhibit a solubility of at least 50 ng/cm²-hr, or at least 100 ng/cm²-hr, or at least 1000 ng/cm²-hr when exposed as a 0.1 g sample to a 0.3 ml/min flow of simulated lung fluid at 37° C.

The high temperature resistant biosoluble alkaline earth silicate fibers may be amorphous inorganic fibers that may be melt-formed and may have an average diameter in the range of 1 to 10 μm, and in certain embodiments, in the range of 2 to 4 μm. While not specifically required, the fibers may be beneficiated, as is known in the art.

In some embodiments, the biosoluble alkaline earth silicate fibers may comprise the fiberization product of a mixture of oxides of calcium, magnesium and silica. These fibers are commonly referred to as calcia-magnesia-silicate fibers. The calcia-magnesia-silicate fibers generally comprise the fiberization product of 45 to 90 weight percent silica, from greater than 0 to 45 weight percent calcia, from greater than 0 to 35 weight percent magnesia, and 10 weight percent or less impurities. Suitable calcia-magnesia-silicate fibers are commercially available from Unifrax I LLC (Tonawanda, N.Y.) under the registered trademark INSULFRAX®. INSULFRAX® fibers generally comprise the fiberization product of 61 to 67 weight percent silica, from 27 to 33 weight percent calcia, and from 2 to 7 weight percent magnesia. Other commercially available calcia-magnesia-silicate fibers comprise 60 to 70 weight percent silica, from 25 to 35 weight percent calcia, from 4 to 7 weight percent magnesia, and trace amounts of alumina; or, 60 to 70 weight percent silica, from 16 to 22 weight percent calcia, from 12 to 19 weight percent magnesia, and trace amounts of alumina.

In some embodiments, the biosoluble alkaline earth silicate fibers may comprise the fiberization product of a mixture of oxides of magnesium and silica, commonly referred to as magnesium-silicate fibers. The magnesium-silicate fibers generally comprise the fiberization product of 60 to 90 weight percent silica, from 5 to 35 weight percent magnesia and 5 weight percent or less impurities. According to certain embodiments, the inorganic fibers comprise the fiberization product of 65 to 86 weight percent silica, 14 to 35 weight percent magnesia, 0 to 7 weight percent zirconia and 5 weight percent or less impurities. According to other embodiments, the inorganic fibers comprise the fiberization product of 70 to 86 weight percent silica, 14 to 30 weight percent magnesia, and 5 weight percent or less impurities. A suitable magnesium-silicate fiber is commercially available from Unifrax I LLC (Tonawanda, N.Y.) under the registered trademark ISOFRAX®. Commercially available ISOFRAX® fibers generally comprise the fiberization product of 70 to 80 weight percent silica, 18 to 27 weight percent magnesia and 4 weight percent or less impurities.

According to certain embodiments, the thermal insulation material may optionally comprise other known non-respirable inorganic fibers (secondary inorganic fibers) such as silica fibers, leached silica fibers (bulk or chopped continuous), S-glass fibers, S2 glass fibers, E-glass fibers, fiberglass fibers, chopped continuous mineral fibers (including but not limited to basalt or diabasic fibers) and combinations thereof and the like, suitable for the particular temperature applications desired. The secondary inorganic fibers are commercially available. For example, silica fibers may be leached using any technique known in the art, such as by subjecting glass fibers to an acid solution or other solution suitable for extracting the non-siliceous oxides and other components from the fibers. A process for making leached glass fibers is disclosed in U.S. Pat. No. 2,624,658 and in European Patent Application Publication No. 0973697.

Examples of suitable silica fibers include those leached glass fibers available from BelChem Fiber Materials GmbH, Germany, under the trademark BELCOTEX® and from Hitco Carbon Composites, Inc. of Gardena, Calif., under the registered trademark REFRASIL®, and from Polotsk-Steklovolokno, Republic of Belarus, under the designation PS-23®. Generally, the leached glass fibers will have a silica content of at least 67 weight percent. In certain embodiments, the leached glass fibers contain at least 90 weight percent, and in certain of these, from 90 weight percent to less than 99 weight percent silica. The fibers are also substantially shot free. The average fiber diameter of these leached glass fibers may be greater than at least 3.5 microns, and often greater than at least 5 microns. On average, the glass fibers typically have a diameter of 9 microns, or up to 14 microns. Thus, these leached glass fibers are non-respirable.

The BELCOTEX® fibers are standard type, staple fiber pre-yarns. These fibers have an average fineness of 550 tex and are generally made from silicic acid modified by alumina. The BELCOTEX® fibers are amorphous and generally contain 94.5 weight percent silica, 4.5 weight percent alumina, less than 0.5 weight percent sodium oxide, and less than 0.5 weight percent of other components. These fibers have an average fiber diameter of 9 microns and a melting point in the range of 1500° to 1550° C. These fibers are heat resistant to temperatures of up to 1100° C. and are typically shot free and binder free.

The REFRASIL® fibers, like the BELCOTEX® fibers, are amorphous leached glass fibers high in silica content for providing thermal insulation for applications in the 1000° to 1100° C. temperature range. These fibers are between 6 and 13 microns in diameter, and have a melting point of about 1700° C. The fibers, after leaching, typically have a silica content of 95 weight percent. Alumina may be present in an amount of about 4 weight percent with other components being present in an amount of 1 weight percent or less.

The PS-23® fibers from Polotsk-Steklovolokno are amorphous glass fibers high in silica content and are suitable for thermal insulation for applications requiring resistance to at least 1000° C. These fibers have a fiber length in the range of 5 to 20 mm and a fiber diameter of 9 microns. These fibers, like the REFRASIL® fibers, have a melting point of about 1700° C.

In certain embodiments, the high temperature resistant inorganic fibers may comprise an alumina/silica/magnesia fiber, such as S-2 Glass from Owens Corning, Toledo, Ohio. The alumina/silica/magnesia S-2 glass fibers typically comprise from 64 weight percent to 66 weight percent SiO₂, from 24 weight percent to 25 weight percent Al₂O₃, and from 9 weight percent to 11 weight percent MgO. S2 glass fibers may have an average diameter of 5 microns to 15 microns and in some embodiments, about 9 microns.

The E-glass fibers typically comprise from 52 weight percent to 56 weight percent SiO₂, from 16 weight percent to 25 weight percent CaO, from 12 weight percent to 16 weight percent Al₂O₃, from 5 weight percent to 10 weight percent B₂O₃, up to 5 weight percent MgO, up to 2 weight percent sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and trace amounts up to 0.3 weight percent of the other above mentioned materials.

The thermal insulation material further comprises an endothermic material. Endothermic materials absorb heat, typically by releasing water of hydration, by going through a phase change that absorbs heat (i.e. liquid to gas), or by other physical or chemical change where the reaction requires a net absorption of heat to take place. When activated, endothermic materials restrict heat transfer. The endothermic material may be selected in view of performance, temperature of the phase change, and safety concerns. For example, a halogen salt being used as an endothermic material would release the halogen counter ion that could fail toxicity tests in some fire applications.

In some embodiments, the endothermic material comprises silicates, metal hydrides, metal hydrates, metal salt hydrates and/or blends thereof. In some embodiments, the endothermic material comprises sodium silicate, silicon carbide, aluminum trihydroxide (Al(OH)₃), magnesium carbonate, and other hydrated inorganic materials including cements, hydrated zinc borate, calcium sulfate (also known as gypsum), magnesium ammonium phosphate, magnesium hydroxide and/or mixtures thereof. In some embodiments, the endothermic material is water soluble. Water solubility may allow for easier application of the endothermic material onto the inorganic fibers, since water soluble materials may be incorporated into fiber lubricants already employed in fiber production processes. In other embodiments, the endothermic material may be water insoluble and may be applied to the inorganic fibers, e.g., in the form of a powder, pellet, or other particle.

In some embodiments wherein the endothermic material is a solid dispersed or entangled within the inorganic fibers, the endothermic material is aluminum trihydroxide. In some embodiments wherein the endothermic material is coated onto the inorganic fibers, the endothermic material is sodium silicate. Sodium silicate, also known as water glass, is soluble in water. In some embodiments, the sodium silicate may have a molar ratio of sodium to silica of 2 to 4, 3 to 4, or 3.5. Sodium silicate is an effective endothermic material since it effectively binds water that may be released upon activation (i.e., exposure to heat).

Materials such as silica and alumina, when present in high concentrations on a ceramic material, may act as a ceramic flux and lower the melting point of the ceramic material. In order to avoid this negative effect in embodiments employing an endothermic material including a potential ceramic flux, the endothermic material may be coated onto surfaces of the inorganic fibers thereby avoiding localized high concentrations of the endothermic material. In some embodiments, based on a total surface area of the inorganic fibers, at least 30%, at least 40%, at least 50%, at least 60%, at least 70%, at least 80%, at least 90%, or 100% of the inorganic fibers is coated by the endothermic material. In other embodiments, the endothermic material may comprise silica and/or alumina powder or pellets that are evenly distributed throughout the inorganic fibers in order to avoid fluxing.

In some embodiments, the endothermic material is incorporated into the thermal insulation material as a liquid, gel, particulate, powder, fiber, or combination thereof. In some embodiments, the endothermic material comprises non-calcined sol-gel fibers, fiberglass, and/or leached silica fibers. In some embodiments, the endothermic material comprises glassy fibers that will densify and crystallize at elevated temperatures. In some embodiments, the thermal insulation material comprises at least two endothermic materials having distinct melting points.

The thermal insulation material may further include one or more binders. Suitable binders include organic binders, inorganic binders and mixtures of these two types of binders. According to certain embodiments, the thermal insulation material includes one or more organic binders. The organic binders may be provided as a solid, a liquid, a solution, a dispersion, a latex, or similar form. The organic binder may comprise a thermoplastic or thermoset binder, which after cure is a flexible material. Examples of suitable organic binders include, but are not limited to, acrylic latex, (meth)acrylic latex, copolymers of styrene and butadiene, vinylpyridine, acrylonitrile, copolymers of acrylonitrile and styrene, vinyl chloride, polyurethane, copolymers of vinyl acetate and ethylene, polyamides, silicones, and the like. Other resin binders include low temperature, flexible thermosetting resins such as unsaturated polyesters, epoxy resins and polyvinyl esters (such as polyvinylacetate or polyvinylbutyrate latexes). According to certain embodiments, the thermal insulation material utilizes an acrylic resin binder.

The organic binder may be included in the thermal insulation material in an amount of from 0 to 50 weight percent, in certain embodiments from 0 to 20 weight percent, and in other embodiments from 0 to 10 weight percent, based on the total weight of the material.

The thermal insulation material may include polymeric binder fibers instead of, or in addition to, a resinous or liquid binder. These polymeric binder fibers, if present, may be used in amounts ranging from greater than 0 to 20 weight percent, in other embodiments from greater than 0 to 10 weight percent, and in further embodiments from 0 to 5 weight percent, based upon 100 weight percent of the total material, to aid in binding the fibers together. Suitable examples of binder fibers include polyvinyl alcohol fibers, polyolefin fibers such as polyethylene and polypropylene, acrylic fibers, polyester fibers, ethyl vinyl acetate fibers, nylon fibers and combinations thereof.

Solvents for the binders, if needed, may include water or a suitable organic solvent, such as acetone, for the binder utilized. Solution strength of the binder in the solvent (if used) can be determined by conventional methods based on the binder loading desired and the workability of the binder system (viscosity, solids content, etc.).

The thermal insulation material may also include an inorganic binder in addition to or in place of the organic binder. The inorganic binder may include, but is not limited to, colloidal silica, colloidal alumina, colloidal zirconia, and mixtures thereof, sodium silicate, and clays, such as bentonite, hectorite, kaolinite, montmorillonite, palygorskite, saponite, or sepiolite, and the like. The inorganic binder may optionally be included in the thermal insulation material in an amount from 0 to 50 weight percent, and in other embodiments from 0 to 25 weight percent, based on the total weight of the thermal insulation material.

An opacifier may optionally be included in the thermal insulation material in an amount from 0 to 20 weight percent, from 0 to 10 weight percent, or from 0 to 5 weight percent, based on the total weight of the thermal insulation material. The opacifier may include carbon black, graphite, titanium dioxide, iron oxide, or zirconium dioxide, as well as mixtures of these. Opacifiers reduce the radiation contribution to thermal conductivity. Additional known additives may be included to provide desirable characteristics, such as fire or flame resistance, mold resistance, pest resistance, mechanical properties, and the like.

In certain embodiments, the thermal insulation material may take the form of an insulation blanket, felt, paper-like material, mat or sheet. In some embodiments, the thermal insulation material may be dry or wet laid and optionally needled. The thermal insulation material may be formed into complex 3D shapes to cover certain applications such as fitting around vehicle batteries.

In some embodiments, the thermal insulation material may be encapsulated in a foil. The foil may include, e.g., aluminum. In some embodiments, a scrim may be included between the thermal insulation material and the foil for reinforcement purposes. The scrim may include, e.g., fiberglass or any other suitable reinforcer. In some embodiments, a material such as an aerogel mat, a low biopersistent (LBP) fiber thin woven blanket, or a polycrystalline wool (PCW) woven blanket can be layered around or within the thermal insulation material to further increase the ability of the thermal insulation material to protect surfaces from fire or thermal exposure. In some embodiments, the foil may be adhered to the thermal insulation material using a binder such as sodium silicate.

In any embodiment, the thermal insulation material may include a hot-face that is a surface proximate a heat source and a cold-face that is a surface opposite the hot-face. In certain embodiments, the endothermic material is activated to maintain the cold-face temperature significantly below what it would be in the absence of the endothermic material.

The thermal insulation material may prevent damage from thermal runaways and/or fires. In some embodiments, the thermal insulation material may be configured for single use protection of equipment and life, such as marine equipment, trains, buses, planes, cars, offices, homes, industrial factories, server rooms, tank cars, cable trays, and the like. Specific examples include, but are not limited to, a grease duct wrap, marine wall panels, cable tray wraps, and lithium ion battery wraps.

In some embodiments, the thermal insulation material is a mat (or blanket) having the endothermic material dispersed or entangled therein. In some embodiments, the mat has a thickness of less than 3 inches, less than 2.5 inches, less than 2 inches, 1 inch to less than 3 inches, 2 inches to less than 3 inches, 2 inches to 2.5 inches, 2 inches, 2.2 inches, 2.5 inches, or 2.7 inches. In some embodiments, a single layer of the mat is adequate to pass the ASTM E2336 test.

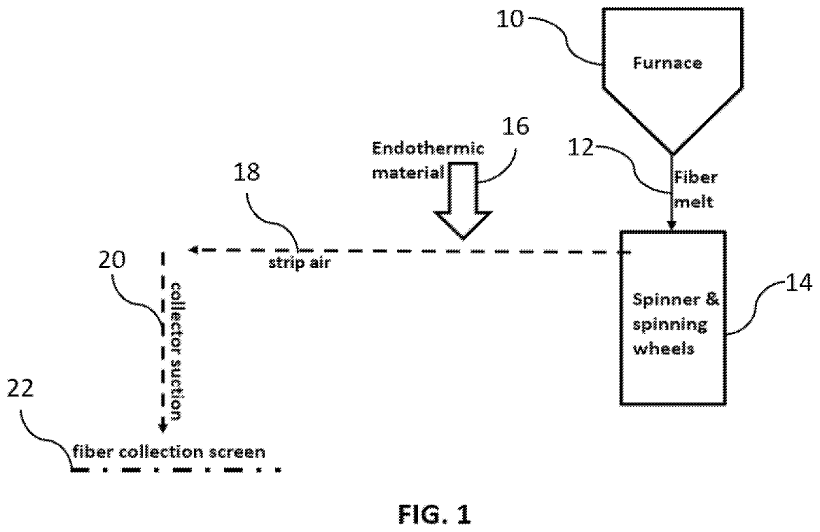

According to one or more embodiments, the mat is formed by a fiber spinning process wherein the endothermic material is introduced into the spinning chamber and entangled into the spun inorganic fibers. For instance, FIG. 1 shows a furnace 10 (such as a submerged electrode furnace (SEF)) which feeds a fiber melt 12 to a spinner and spinning wheels 14 to produce the inorganic fibers, which are further attenuated by the strip air 18 (i.e., an air jet). As shown in FIG. 1, the endothermic material may be introduced via an endothermic material supply 16 into the strip air 18 flow such that the endothermic material is evenly distributed and entangled in the inorganic fibers (which may form an inorganic fiber web), as collected in the fiber collection screen 22. In some embodiments, transfer of the inorganic fibers and endothermic material to the collection screen 22 may be facilitated by a collector suction 20. In some embodiments, the rate of introducing the endothermic material may be tailored to provide a desired content of endothermic material within the inorganic fiber web.

After collection, the inorganic fibers having endothermic material dispersed therein may be needled to the appropriate thickness and density. For example, the needled mat may have a density of 7 to 20 pounds per cubic foot (“PCF”), 10-20 PCF, 10-15 PCF, or 12-14 PCF.

In other embodiments, the endothermic material may be dispersed within the inorganic fibers using electrostatic methods or other types of dry lay processes (with and without binders and/or non-woven processes) and wet laid processes such as paper making. However, as compared to the process shown in FIG. 1, these methods create additional step(s), which adds to the cost of the finished product.

### EXAMPLES

### Example 1

Needled fiber mats were prepared using an SEF furnace and a spinning process, similar to that shown in FIG. 1. The inorganic fibers comprised silica, magnesia, and calcia. The mats were tested according to ASTM E2336. The mat compositions and results are summarized in Table 1 below:

TABLE 1

| | | | Total | | Time Below | |
|---|---|---|---|---|---|---|
| | Thickness | Density | Weight | Al(OH)₃ | 325° F. | Pass/ |
| Sample | (in) | (PCF) | (g) | Weight (g) | (min) | Fail |
| C1 | 2.5 | 10.9 | 1032 | N/A | 24.5 | Fail |
| C2 | 1.5 | 9.5 | 540 | N/A | 7 | Fail |
| 1 | 2.25 | 14 | 1228 | 630 | 56.5 | Pass |
| 2 | 1.75 | 15.8 | 1035 | 504 | 31.5 | Pass |
| 3 | 2.0 | 12.5 | 961 | 490 | 31.5 | Pass |

As shown in Table 1, samples 1-3 provided remarkably improved insulation without increasing the thickness of the mat. In fact, all of samples 1-3 were thinner than comparative sample C1, yet each of sample 1-3 provided at least 7 minutes more time below the threshold temperature of 325° F. Additionally, comparative sample C2 included approximately the same amount of inorganic fibers as sample 2 while sample 2 included an additional 504 g of aluminum trihydroxide (only 0.25 inches thicker), yet sample C2 only lasted for 7 minutes as compared with the 31.5 minutes for sample 2.

### Example 2

As a reference, FYREWRAP® ELITE® 1.5 Duct Insulation, including two 1.5-inch encapsulated thermal blankets (total thickness of 3 inches) was tested according to ASTM E2336. Additionally, INSULFRAX® fibers coated with sodium silicate were formed into an encapsulated thermal blanket having a thickness of 2.7 inches. A single layer of this thermal blanket was also tested according to ASTM E2336.

The single-layer thermal insulation according to the present disclosure performed as well as the double-layer FYREWRAP® ELITE® 1.5 Duct Insulation and passed the ASTM E2336 test. In particular, each sample maintained a cold face differential (from ambient temperature) of less than 325° F. for about 40 minutes after the hot face reached 2000° F. This is despite the single-layer thermal insulation being thinner (2.7 inches as compared with 3 inches) and less dense (9 PCF (pound per cubic foot) as compared with 10 PCF).

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A thermal insulation material comprising:
inorganic fibers; and
an endothermic material dispersed throughout the inorganic fibers;
wherein the endothermic material is dispersed throughout the inorganic fibers during a fiber attenuation process.

2. The material of claim 1, wherein the endothermic material comprises sodium silicate and/or aluminum trihydroxide.

3. The material of claim 1, wherein the inorganic fibers form a web and the endothermic material is entangled within the web.

4. The material of claim 3, wherein the endothermic material is aluminum trihydroxide.

5. The material of claim 4, wherein the aluminum trihydroxide constitutes 30 to 70 wt % based on a total weight of the inorganic fibers and the endothermic material.

6. The material of claim 1, wherein the endothermic material is coated onto surfaces of the inorganic fibers.

7. The material of claim 6, wherein the endothermic material is sodium silicate.

8. The material of claim 7, wherein the sodium silicate constitutes 10-20 wt % based on a total weight of the inorganic fibers and the endothermic material.

9. A method of forming a thermal insulation material, comprising:
forming a web of inorganic fibers; and
while forming the web of inorganic fibers, dispersing an endothermic material within the inorganic fibers.

10. The method of claim 9, wherein forming the web of inorganic fibers comprises a spinning process.

11. The method of claim 10, wherein the spinning process comprises attenuating the inorganic fibers using an air jet and wherein dispersing the endothermic material comprises introducing the endothermic material into the air jet.

12. The method of claim 11, wherein the endothermic material comprises aluminum trihydroxide.

13. The method of claim 12, wherein the aluminum trihydroxide constitutes 30-70 wt % based on a total weight of the inorganic fibers and the endothermic material.

14. A system for forming a thermal insulation material, comprising:
a furnace configured to melt an inorganic fiber composition and release said melted composition through an outlet of the furnace;
an attenuator configured to attenuate the melted composition to form inorganic fibers therefrom;
an endothermic material source comprising an endothermic material and configured to disperse said endothermic material into the inorganic fibers; and
a collection screen configured to collect the thermal insulation material comprising the endothermic material dispersed within the inorganic fibers.

15. The system of claim 14, wherein the attenuator comprises a spinning wheel and compressed air.

16. The system of claim 15, wherein the endothermic material source is configured to disperse the endothermic material into a stream of the compressed air.

17. The system of claim 14, wherein the endothermic material wherein the endothermic material comprises aluminum trihydroxide.

18. The system of claim 17, wherein the aluminum trihydroxide constitutes 30-70 wt % based on a total weight of the thermal insulation material at the collection screen.

19. The system of claim 14, wherein the endothermic material is sodium silicate.

20. The system of claim 19, wherein the sodium silicate constitutes 10-20 wt % based on a total weight of the thermal insulation material at the collection screen.
